(19) United States
(12) Patent Application Publication
(10) Pub. No.: US 2009/0325846 A1
(43) Pub. Date: Dec. 31, 2009

(54) Spray-Drying Process

(76) Inventors: Hossam Hassan Tantawy, Northumberland (GB); Nigel Patrick Somerville Roberts, Tyne (GB); Urwin Harrogate, Northumberland (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/486,776

(22) Filed: Jun. 18, 2009

(30) Foreign Application Priority Data
Jun. 25, 2008 (EP) 08159034.1

(51) Int. Cl. C11D 3/06

(52) U.S. Cl. 510/276

(57) ABSTRACT

The present invention relates to a process for preparing a spray-dried powder comprising: (i) anionic detersive surfactant; (ii) from 0 wt % to 10 wt % zeolite builder; (iii) from 0 wt % to 10 wt % phosphate builder; and (iv) from 3 wt % to 15 wt % silicate salt; the process comprising the steps of: (a) heating an aqueous slurry to a temperature above 100° C. to form a heated slurry; and (b) spraying the heated slurry at temperature above 100° C. into a spray-drying tower; (c) spray-drying the slurry to form a spray-dried powder.

### FIELD OF THE INVENTION

The present invention relates to a spray-drying process.

### BACKGROUND OF THE INVENTION

There is a recent trend in the laundry detergent industry to produce low-built laundry powders. These are typically produced by a spray-drying process. However, the low-built spray-dried powder produced by these spray-drying processes has a poor stability profile. This is exacerbated when a significant amount of silicate salt is present in the spray-dried powder. The Inventors have overcome this problem by heating the aqueous slurry above the boiling point of water, and spraying it at this elevated temperature into a spray-drying tower. The Inventors have found that the low built spray-dried powders produced by the process of the present invention exhibit an improved stability profile.

### SUMMARY OF THE INVENTION

The present invention relates to a process as defined in claim 1.

### DETAILED DESCRIPTION OF THE INVENTION

### Process for Preparing a Spray-Dried Powder

The process comprises the steps of: (a) heating an aqueous slurry to a temperature above 100° C. to form a heated slurry; and (b) spraying the heated slurry at temperature above 100° C. into a spray-drying tower; (c) spray-drying the slurry to form a spray-dried powder.

Preferably, in step (a), the aqueous slurry is heated to a temperature above 105° C., or above 110° C., or above 115° C., or above 120° C., or even at least 123° C., or even above 125° C.

Preferably, the heated slurry is sprayed at a temperature above 105° C., or above 110° C., or above 115° C., or above 120° C., or even above 125° C. into the spray-drying tower.

Preferably, the heated slurry is sprayed at a pressure of at least 4×10⁶ Pa, or at least 5×10⁶ Pa, or at least 6×10⁶ Pa, or at least 7×10⁶ Pa, or even at least 8×10⁶ Pa into the spray-drying tower.

Preferably, the slurry heated by the addition of saturated steam, typically at elevated pressure.

The slurry can be heated by a chemical or nuclear exothermic reaction. The slurry may be heated by solar energy.

Preferably, the slurry is heated by a chemical exothermic reaction, preferably an in-situ exothermic reaction, most preferably an in-situ exothermic neutralization reaction, such as the neutralization of an acid anionic surfactant precursor. The use of an in-situ exothermic reaction as a heat source avoids the problems of fouling the internal pipe surfaces that may occur when external direct heat is applied.

Preferably, the spray-dried powder is contacted with non-ionic detersive surfactant.

### Spray-Dried Powder

The spray-dried powder comprises: (i) anionic detersive surfactant; (ii) from 0 wt % to 10 wt % zeolite builder; (iii) from 0 wt % to 10 wt % phosphate builder; and (iv) from 3 wt % to 15 wt % silicate salt. The spray-dried powder may also comprise carbonate salt.

The spray-dried powder typically comprises adjunct detergent ingredients.

### Anionic Detersive Surfactant

The anionic detersive surfactant preferably comprises alkyl benzene sulphonate. Preferably the anionic detersive surfactant comprises at least 50%, preferably at least 55%, or at least 60%, or at least 65%, or at least 70%, or even at least 75%, by weight of the anionic detersive surfactant, of alkyl benzene sulphonate. Preferably the alkyl benzene sulphonate is a linear or branched, substituted or unsubstituted, C₈₋₁₈ alkyl benzene sulphonate. This is the optimal level of the C₈₋₁₈ alkyl benzene sulphonate to provide a good cleaning performance. The C₈₋₁₈ alkyl benzene sulphonate can be a modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548. Highly preferred C₈₋₁₈ alkyl benzene sulphonates are linear C₁₀₋₁₃ alkylbenzene sulphonates. Especially preferred are linear C₁₀₋₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

The anionic detersive surfactant may preferably comprise other anionic detersive surfactants. A preferred adjunct anionic detersive surfactant is a non-alkoxylated anionic detersive surfactant. The non-alkoxylated anionic detersive surfactant can be an alkyl sulphate, an alkyl phosphate, an alkyl phosphonate, an alkyl carboxylate or any mixture thereof. The non-alkoxylated anionic surfactant can be selected from the group consisting of; C₁₀-C₂₀ primary, branched-chain, linear-chain and random-chain alkyl sulphates (AS), typically having the following formula:

CH₃(CH₂)ₓCH₂—OSO₃⁻M⁺

wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae:

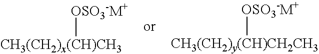

wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl carboxylates; mid-chain branched alkyl sulphates as described in more detail in U.S. Pat. No. 6,020,303 and U.S. Pat. No. 6,060,443; methyl ester sulphonate (MES); alpha-olefin sulphonate (AOS); and mixtures thereof.

Another preferred anionic detersive surfactant is an alkoxylated anionic detersive surfactant. The presence of an alkoxylated anionic detersive surfactant in the spray-dried powder provides good greasy soil cleaning performance, gives a good sudsing profile, and improves the hardness tolerance of the anionic detersive surfactant system. It may be preferred for the anionic detersive surfactant to comprise from 1% to 50%, or from 5%, or from 10%, or from 15%, or from 20%, and to 45%, or to 40%, or to 35%, or to 30%, by weight of the anionic detersive surfactant system, of an alkoxylated anionic detersive surfactant.

Preferably, the alkoxylated anionic detersive surfactant is a linear or branched, substituted or unsubstituted C₁₂₋₁₈ alkyl alkoxylated sulphate having an average degree of alkoxylation of from 1 to 30, preferably from 1 to 10. Preferably, the alkoxylated anionic detersive surfactant is a linear or branched, substituted or unsubstituted C₁₂₋₁₈ alkyl ethoxylated sulphate having an average degree of ethoxylation of from 1 to 10. Most preferably, the alkoxylated anionic detersive surfactant is a linear unsubstituted C₁₂₋₁₈ alkyl ethoxylated sulphate having an average degree of ethoxylation of from 3 to 7.

The alkoxylated anionic detersive surfactant, when present with an alkyl benzene sulphonate may also increase the activity of the alkyl benzene sulphonate by making the alkyl benzene sulphonate less likely to precipitate out of solution in the presence of free calcium cations. Preferably, the weight ratio of the alkyl benzene sulphonate to the alkoxylated anionic detersive surfactant is in the range of from 1:1 to less than 5:1, or to less than 3:1, or to less than 1.7:1, or even less than 1.5:1. This ratio gives optimal whiteness maintenance performance combined with a good hardness tolerance profile and a good sudsing profile. However, it may be preferred that the weight ratio of the alkyl benzene sulphonate to the alkoxylated anionic detersive surfactant is greater than 5:1, or greater than 6:1, or greater than 7:1, or even greater than 10:1. This ratio gives optimal greasy soil cleaning performance combined with a good hardness tolerance profile, and a good sudsing profile.

Suitable alkoxylated anionic detersive surfactants are: Texapan LEST™ by Cognis; Cosmacol AES™ by Sasol; BES151™ by Stephan; Empicol ESC70/U™; and mixtures thereof.

Preferably, the anionic detersive surfactant comprises from 0% to 10%, preferably to 8%, or to 6%, or to 4%, or to 2%, or even to 1%, by weight of the anionic detersive surfactant, of unsaturated anionic detersive surfactants such as alpha-olefin sulphonate. Preferably the anionic detersive surfactant is essentially free of unsaturated anionic detersive surfactants such as alpha-olefin sulphonate. By “essentially free of” it is typically meant “comprises no deliberately added”. Without wishing to be bound by theory, it is believed that these levels of unsaturated anionic detersive surfactants such as alpha-olefin sulphonate ensure that the anionic detersive surfactant is bleach compatible.

Preferably, the anionic detersive surfactant comprises from 0% to 10%, preferably to 8%, or to 6%, or to 4%, or to 2%, or even to 1%, by weight of alkyl sulphate. Preferably the anionic detersive surfactant is essentially free of alkyl sulphate. Without wishing to be bound by theory, it is believed that these levels of alkyl sulphate ensure that the anionic detersive surfactant is hardness tolerant.

### Zeolite Builder

The spray-dried powder typically comprises from 0% to 10 wt % zeolite builder, preferably to 9 wt %, or to 8 wt %, or to 7 w %, or to 6 wt %, or to 5 wt %, or to 4 wt %, or to 3 wt %, or to 2 wt %, or to 1 wt %, or to less than 1% by weight of the spray-dried powder, of zeolite builder. It may even be preferred for the spray-dried powder to be essentially free from zeolite builder. By essentially free from zeolite builder it is typically meant that the spray-dried powder comprises no deliberately added zeolite builder. This is especially preferred if it is desirable for the spray-dried powder to be very highly soluble, to minimise the amount of water-insoluble residues (for example, which may deposit on fabric surfaces), and also when it is highly desirable to have transparent wash liquor. Zeolite builders include zeolite A, zeolite X, zeolite P and zeolite MAP.

### Phosphate Builder

The spray-dried powder typically comprises from 0% to 10 wt % phosphate builder, preferably to 9 wt %, or to 8 wt %, or to 7 wt %, or to 6 wt %, or to 5 wt %, or to 4 wt %, or to 3 wt %, or to 2 wt %, or to 1 wt %, or to less than 1% by weight of the spray-dried powder, of phosphate builder. It may even be preferred for the spray-dried powder to be essentially free from phosphate builder. By essentially free from phosphate builder it is typically meant that the spray-dried powder comprises no deliberately added phosphate builder. This is especially preferred if it is desirable for the composition to have a very good environmental profile. Phosphate builders include sodium tripolyphosphate.

### Silicate Salt

The spray-dried powder optionally comprises from 0% to 20 wt % silicate salt, preferably from 1 wt %, or from 2 wt %, or from 3 wt %, and preferably to 15 wt %, or to 10 wt %, or even to 5% silicate salt. Silicate salts include amorphous silicates and crystalline layered silicates (e.g. SKS-6). A preferred silicate salt is sodium silicate.

### Carbonate Salt

The spray-dried powder typically comprises carbonate salt, typically from 1% to 50%, or from 5% to 25% or from 10% to 20%, by weight of the spray-dried powder, of carbonate salt. A preferred carbonate salt is sodium carbonate and/or sodium bicarbonate. A highly preferred carbonate salt is sodium carbonate. Preferably, the spray-dried powder may comprise from 10% to 40%, by weight of the spray-dried powder, of sodium carbonate. However, it may also be preferred for the spray-dried powder to comprise from 2% to 8%, by weight of the spray-dried powder, of sodium bicarbonate. Sodium bicarbonate at these levels provides good alkalinity whilst minimizing the risk of surfactant gelling which may occur in surfactant-carbonate systems. If the spray-dried powder comprises sodium carbonate and zeolite, then preferably the weight ratio of sodium carbonate to zeolite is at least 15:1.

High levels of carbonate improve the cleaning performance of the composition by increasing the pH of the wash liquor. This increased alkalinity: improves the performance of the bleach, if present; increases the tendency of soils to hydrolyse, which facilitates their removal from the fabric; and also increases the rate, and degree, of ionization of the soils to be cleaned (n.b. ionized soils are more soluble and easier to remove from the fabrics during the washing stage of the laundering process). In addition, high carbonate levels improve the flowability of the spray-dried powder.

### Adjunct Detergent Ingredients

Suitable adjunct ingredients include: detersive surfactants such as anionic detersive surfactants, nonionic detersive surfactants, cationic detersive surfactants, zwitterionic detersive surfactants, amphoteric detersive surfactants; preferred nonionic detersive surfactants are C₈₋₁₈ alkyl alkoxylated alcohols having an average degree of alkoxylation of from 1 to 20, preferably from 3 to 10, most preferred are C₁₂₋₁₈ alkyl ethoxylated alcohols having an average degree of alkoxylation of from 3 to 10; preferred cationic detersive surfactants are mono-C₆₋₁₈ alkyl mono-hydroxyethyl di-methyl quaternary ammonium chlorides, more preferred are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; enzymes such as amylases, carbohydrases, cellulases, laccases, lipases, oxidases, peroxidases, proteases, pectate lyases and mannanases; suds suppressing systems such as silicone based suds suppressors; fluorescent whitening agents; photobleach; filler salts such as sulphate salts, preferably sodium sulphate; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as alkoxylated polyamines and ethoxylated ethyleneimine polymers; anti-redeposition components such as carboxymethyl cellulose and polyesters; perfumes; sulphamic acid or salts thereof; citric acid or salts thereof; and dyes such as orange dye, blue dye, green dye, purple dye, pink dye, or any mixture thereof.

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

### A Spray-Dried Laundry Detergent Powder and Process of Making It

### Aqueous Alkaline Slurry Composition.

| Component | Aqueous slurry (parts) |
|---|---|
| Sodium Silicate | 8.5 |
| Acrylate/maleate copolymer | 3.2 |
| Hydroxyethane di(methylene phosphonic acid) | 0.6 |
| Sodium carbonate | 8.8 |
| Sodium sulphate | 42.9 |
| Water | 19.7 |
| Miscellaneous, such as magnesium sulphate, | 1.7 |
| and one or more stabilizers | |
| Aqueous alkaline slurry parts | 85.4 |

### Preparation of a Spray-Dried Laundry Detergent Powder.

An alkaline aqueous slurry having the composition as described above is prepared in a slurry making vessel (crutcher). The moisture content of the above slurry is 23.1%. Any ingredient added above in liquid form is heated to 70° C., such that the aqueous slurry is never at a temperature below 70° C. Saturated steam at a pressure of 6.0×10⁵ Pa is injected into the crutcher to raise the temperature to 90° C. The slurry is then transferred into a low pressure line (having a pressure of 5.0×10⁵ Pa).

Separately, 11.4 parts of linear alkylbenzene sulphonic acid (HLAS), and 3.2 parts of a 50 w/w % aqueous sodium hydroxide solution are pumped into the low pressure line. In addition, saturated steam at a pressure of 6.0×10⁵ Pa is injected into the low pressure line*. The mixture is then pumped by a high pressure pump into a high pressure line (having an exit pressure of 8.0×10⁶ Pa). The mixture is then sprayed at a rate of 1,640 kg/hour at a pressure of 8.0×10⁶ Pa and at a temperature of 125° C.±2° C. into a counter current spray-drying tower with an air inlet temperature of 275° C. The mixture is atomised and the atomised slurry is dried to produce a solid mixture, which is then cooled and sieved to remove oversize material (>1.8 mm) to form a spray-dried powder, which is free-flowing. Fine material (<0.15 mm) is elutriated with the exhaust the exhaust air in the spray-drying tower and collected in a post tower containment system. The spray-dried powder has a moisture content of 2.5 wt %, a bulk density of 510 g/l and a particle size distribution such that greater than 80 wt % of the spray-dried powder has a particle size of from 150 to 710 micrometers. The composition of the spray-dried powder is given below.

*The mass flow rate of saturated steam into the low pressure line is controlled by a temperature feedback controller that controls the temperature of the slurry entering the high pressure pump. The slurry temperature entering the high pressure pump is maintained at 125° C.±2° C.

### Spray-Dried Laundry Detergent Powder Composition

| Component | % w/w Spray Dried Powder |
|---|---|
| Sodium silicate salt | 10.0 |
| Linear alkyl benzene sulphonate | 15.1 |
| Acrylate/maleate copolymer | 4.0 |
| Hydroxyethane di(methylene | 0.7 |
| phosphonic acid) | |
| Sodium carbonate | 11.9 |
| Sodium sulphate | 53.7 |
| Water | 2.5 |
| Miscellaneous, such as magnesium sulphate, | 2.1 |
| and one or more stabilizers | |
| Total Parts | 100.00 |

### A Granular Laundry Detergent Composition.

| | % w/w granular |
|---|---|
| | laundry detergent |
| Component | composition |
| Spray-dried powder of example 1 (described above) | 59.38 |
| 91.6 wt % active linear alkyl benzene sulphonate flake | 0.22 |
| supplied by Stepan under the tradename | |
| Nacconol 90G ® Citric acid | 5.00 |
| Sodium percarbonate (having from 12% to | 14.70 |
| 15% active AvOx) | |
| Photobleach particle | 0.01 |
| Lipase (11.00 mg active/g) | 0.70 |
| Amylase (21.55 mg active/g) | 0.33 |
| Protease (56.00 mg active/g) | 0.43 |
| Tetraacetyl ethylene diamine agglomerate | 4.35 |
| (92 wt % active) | |
| Suds suppressor agglomerate (11.5 wt % active) | 0.87 |
| Acrylate/maleate copolymer particle | 0.29 |
| (95.7 wt % active) | |
| Green/Blue carbonate speckle | 0.50 |
| Sodium Sulphate | 9.59 |
| Solid perfume particle | 0.63 |
| Ethoxylated C₁₂-C₁₈ alcohol having an average degree | 3.00 |
| of ethoxylation of 7 (AE7) | |
| Total Parts | 100.00 |

The above laundry detergent composition was prepared by dry-mixing all of the above particles (all except the AE7) in a standard batch mixer. The AE7 in liquid form is sprayed on the particles in the standard batch mixer. Alternatively, the AE7 in liquid form is sprayed onto the spray-dried powder of example 1. The resultant powder is then mixed with all of the other particles in a standard batch mixer.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for preparing a spray-dried powder comprising:
(i) anionic detersive surfactant;
(ii) from about 0 wt % to about 10 wt % zeolite builder;
(iii) from about 0 wt % to about 10 wt % phosphate builder; and
(iv) from about 3 wt % to about 15 wt % silicate salt;
the process comprising the steps of:
(a) heating an aqueous slurry to a temperature above about 100° C. to form a heated slurry; and
(b) spraying the heated slurry at temperature above about 100° C. into a spray-drying tower;
(c) spray-drying the slurry to form a spray-dried powder.

2. A process according to claim 1, wherein the aqueous slurry is heated to a temperature at least about 123° C.

3. A process according to claim 1, wherein the heated slurry is sprayed at a temperature of at least about 123° C. into the spray-drying tower.

4. A process according to claim 1, wherein the heated slurry is sprayed at a pressure of at least about 4×10⁶ Pa into the spray-drying tower.

5. A process according to claim 1, wherein the slurry is heated by the addition of saturated steam.

6. A process according to claim 1, wherein the slurry is heated by a chemical or nuclear exothermic reaction.

7. A process according to claim 1, wherein the slurry is heated by solar energy.

8. A process according to claim 1, wherein the spray-dried powder is contacted with non-ionic detersive surfactant.
